(19) United States
(12) Patent Application Publication
(10) Pub. No.: US 2005/0240498 A1
(43) Pub. Date: Oct. 27, 2005

(54) Product verification and activation system, method and apparatus

(76) Inventor: Arnold Thaler, Weston, FL (US)

Correspondence Address: BAKER BOTTS, LLP, 910 LOUISIANA, HOUSTON, TX, 77002-4995, US

(21) Appl. No.: 10/829,667

(22) Filed: Apr. 22, 2004

(51) Int. Cl. G06F 17/60; H04K 1/00; H04L 9/00; H04L 9/32; G06F 11/30; G06F 12/14

(52) U.S. Cl. 705/29; 705/50

(57) ABSTRACT

A verification and activation module for a product remembers where the product was purchased, the purchase date, purchase price, length of warranty, name and address of purchasing consumer, etc. The verification and activation module may enable operation of the product, enable operation of a replacement product and disable a defective product that has been replaced under warranty or after an out of warranty service exchange. It may be removable from the product and may be packed separately or installed in the product. It may be programmed at the time of product purchase using wireless means, e.g., radio frequency identification (RFID), infrared (IRD), or by direct electrical connection to a programmer at the point of sale. An optical scanner at the point of sale may be used to scan information from a UPC label on the product package and either through the wireless or direct electrical connection can program the verification and activation module from the scanned UPC and other information and additional information, e.g., store name and location, purchase price, purchase date, serial number of product, manufacturer, product model number, warranty duration, consumer name, address and other desired information. The verification and activation module may include a non-volatile memory. Warranty, repair and replacement histories may be retained for later retrieval in the non-volatile memory of the verification and activation module. The verification and activation module may also be used for security purposes to render the product inoperable if a certain security condition is not met.

### BACKGROUND OF THE INVENTION TECHNOLOGY

1. Field of the Invention

The present invention relates to products, and more specifically, to a system, method and apparatus for verification and activation of the products, particularly, but without limitation, consumer products.

2. Background of the Related Technology

Retail sales stores depend on consumer satisfaction. As such, many retail stores take the position that the “consumer is always right.” However, some consumers take advantage of the consumer friendly policies of the retail stores and return products that they don't like, may be out of warranty, not purchased from that store, and/or falsely state the purchase price to be greater than the actual price paid. Generally, the consumer uses the excuse that he or she lost the sales receipt while perpetrating the fraudulent return of the product. These fraudulent product returns cost the stores and manufacturers a lot of money, and factor into increased retail sales prices that all consumers have to pay. The manufacturer may have to accept return of its branded product from the retail store, give the retail store credit for the returned branded product and pay the store a handling fee relating to the returned branded product. The manufacturers cannot resell the returned products because they are used, so that the returned products, generally, are a total loss to the manufacturers. Another problem exists for manufacturers when defective products, especially those that are branded, are sold to unsuspecting buyers through garage sales, online websites like E-bay, secondhand stores and the like. Warranty claims and/or lawsuits against the original manufacturer company may arise from the unsuspecting buyers because the prior owner(s) of the product alleged to be defective may have disappeared or become insolvent.

Therefore, a problem exists, and a solution is required for preventing fraudulent return of a product by determining the store at which the product was purchased, the sale date, the purchase price and date of first activation. Prevention of the further operation of a defective product when replaced under warranty is also needed.

### SUMMARY OF THE INVENTION

For the sake of clarity and convenience, the various embodiments are described herein in the context of consumer products. However, the present invention also may be useful in other applications, such as professional products, disposable or one-time use products, etc., which are not products of the type typically sold through consumer retail outlets (e.g., mass merchant stores, department stores, home centers, hardware stores, discounters, liquidators, electronic, club, specialty catalog, other specialty facilities), but which may be, by way of example, distributed to or through industrial or commercial applications for use therein.

The present invention remedies the shortcomings of product sales to a consumer by providing a system, method and apparatus for verifying and activating a product sold to the consumer. The invention may comprise a verification and activation module that may be used to record the store where the product was purchased, the purchase date, purchase price, length of warranty, name and address of purchasing consumer, etc. The verification and activation module may also be used to enable operation of the product, enable operation of a replacement product and disable a defective product that has been replaced under warranty or after an out of warranty service exchange. An optional feature of the verification and activation module is that once the verification and activation module has enabled operation of the replacement product, the original product cannot be reactivated using the verification and activation module. In effect the verification and activation module determines that a replacement product has been enabled and the original product that the verification and activation module had been associated with should no longer be operable. Verification and activation module duplicating or pirating may be prevented by a number of methods and circuits well know in security systems, e.g., rolling code like used in garage door opener systems. Thus, a verification and activation module that has been removed from a first product and used to activate another product, can no longer be used to reactivate the first product. The verification and activation module may assimilate characteristics of the replacement product so that it no longer may be usable in a product it has activated in the past.

According to embodiments of the invention, the verification and activation module may be removably associated with the product and may be packed separately or installed in the product. The verification and activation module may be programmed at the time of product purchase using wireless means, e.g., radio frequency identification (RFID), infrared (IRD), by direct electrical connection to a programmer at the point of sale, etc. An optical scanner at the point of sale may be used to scan information from a Universal Product Code (UPC) label on the product package. The UPC is coded as a bar code and is commonly found on products for identifying each product and for making it easy to determine price at the time of sale.

The predefined product code is read into the computer by passing the bar code scanner over the UPC label and either a wireless or direct electrical connection may program the verification and activation module from the scanned UPC information and additional information, e.g., store name and location, purchase price, purchase date, serial number of product, manufacturer, product model number, warranty duration, consumer name, address and other desired information. The verification and activation module may comprise a non-volatile memory, e.g., flash memory card, USB memory stick, memory module, PCMCIA card, programmable non-volatile RFID device and the like. An RFID device packaged with the product also may allow or assist with in store security and inventory tracking of the packaged product.

The verification and activation module need not be specific to any particular product, rather it may be programmed for the associated product at the time and point of sale thereof. In this way a general, standardized verification and activation module may be used for many different types of products so the cost thereof may be kept low. The form factor of the verification and activation module may depend upon the size of the product and ease of handling by the store personnel and/or purchasing consumer. A smaller product may require a smaller form factor verification and activation module.

The verification and activation module may alternatively be a non-removable integral part of the product and may be programmed by either a wireless programmer, e.g., RFID or a direct connection to the product. An original product and its non-removable integral verification and activation module may further have the capability of transferring stored information to a replacement product and its removable or non-removable integral verification and activation module. When the information from the original product has been transferred to the replacement product, the replacement product may become activated and the original product may become deactivated.

The verification and activation module may also be used for storing service and warranty information of the product, e.g., required maintenance performed, repair history, etc. Thus, if a product is replaced or repaired under warranty the verification and activation module can maintain a history of warranty and/or repair activities for the product throughout any repair and/or replacement thereof. This product history may be useful for product studies, e.g., reliability, warranty costs, product recalls, updates, consumer use patterns, etc. The product history may be updated and/or read via a connection to a communications port of the product, e.g., wireless, Ethernet, etc., e.g., over a telephone modem or the Internet.

The verification and activation module may also be used for security and/or theft deterrence. A product may be activated at its point of use, e.g., home or office kitchen, family room, etc., and if moved from its intended point of use, the product may be disabled by the verification and activation module. The product may comprise a global position satellite (GPS) system that may determine the location of the product and a code may be entered to activate the product at that location. If the product is moved outside of a certain distance from that GPS determined location, the product may be deactivated unless a reactivation code is entered into the product at its new location. A cellular or satellite communication system may be included into the product so that the product can “call for help” if the reactivation code is not forthcoming. In effect the product knows that it has been stolen because of a change in location without confirmation that the location change was authorized, and thereby may deactivate and further may alert where it is now located.

Security activation of the product through the verification and activation module may be performed over a wireless digital network, e.g., Wireless Fidelity (WiFi) technology, Bluetooth, etc., that operates within defined geographical boundaries. If the product is removed outside of the defined geographical boundaries, it ceases to function. Thus, if a product is stolen and removed from the rightful owner's home or office, the product may render itself useless. A security code, e.g., a rolling code may be used within the wireless technology so that the security code may not be easily replicated. Carrier current communications is also contemplated herein and may be used to communicate with the product once it is plugged into a power outlet. Communications may be with a computer network server and access may also be available to the Internet. This security activation may be used in combination with home and office automation of products therein. A “heartbeat” may be used to determine the presence of a product over a network and if the presence of the product is not sensed, an alarm may be generated to a security monitoring system.

A technical advantage of the present invention is recording and storing event and/or transaction information, e.g., the location where the product was purchased, the purchase date, purchase price, length of warranty, name and address of purchasing consumer, etc. Another technical advantage is to enable operation of the product, enable operation of a replacement product and, if applicable, appropriately disable a product, e.g., a defective product that has been replaced under warranty or after an out of warranty service exchange. Still another technical advantage is once the verification and activation module has enabled operation of a replacement product, the original product cannot be reactivated using the verification and activation module. Yet another technical advantage is use of a security system to prevent unauthorized use and duplication of the verification and activation module. Still another technical advantage is reading a UPC on a product label and entering the UPC information along with event and/or transaction information, e.g., customer personal and/or purchase information, into the verification and activation module of the product. Still another technical advantage is wirelessly programming the verification and activation module. Another technical advantage is an original product being able to transfer product warranty, consumer and store information to a replacement product when a warranty or upgrade exchange occurs. Another technical advantage is retention of warranty repair and replacement history. Yet another technical advantage is security of the product and deactivation upon attempted unauthorized use thereof. Other technical advantages should be apparent to one of ordinary skill in the art in view of what has been disclosed herein.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a schematic front elevational view of an exemplary consumer product;

FIG. 2 is a schematic bottom view of the product of FIG. 1 showing a possible location of a verification and activation module;

FIG. 3 is a schematic system block diagram of one embodiment of a product and its verification and activation module in a package and checkout equipment at the point of sale;

FIG. 4 is a process flow diagram of steps performed at the point of sale of the product, according to one embodiment;

FIG. 5 is a process flow diagram of steps performed when the consumer unpacks and first uses the product, according to one embodiment;

FIG. 6 is a process flow diagram of steps performed when the consumer replaces a defective product with a replacement product, according to one embodiment; and

FIGS. 7(a) and 7(b) are schematic system block diagrams of two different embodiments of the product and its verification and activation module.

The present invention may be susceptible to various modifications and alternative forms. Specific examples thereof are shown by way of example in the drawing and are described herein in detail. It should be understood, however, that the description set forth herein of specific embodiments is not intended to limit the present invention to the particular forms disclosed. Rather, all modifications, alternatives, and equivalents falling within the spirit and scope of the invention as defined by the appended claims are intended to be covered.

### DETAILED DESCRIPTION OF SPECIFIC EMBODIMENTS

Referring now to the drawings, the details of exemplary embodiments of the present invention are schematically illustrated. Like elements in the drawings will be represented by like numbers, and similar elements will be represented by like numbers with a different lower case letter.

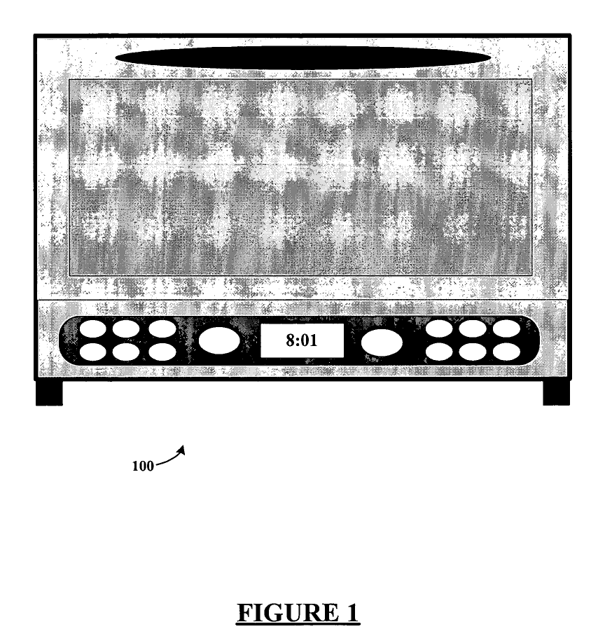

Referring now to FIG. 1, depicted is a schematic front elevational view of an exemplary consumer product, generally represented by the numeral 100. The product 100 shown in FIG. 1 is a toaster oven, however, it is contemplated and within the scope of the invention disclosed herein, that the invention may be utilized with any consumer, commercial and/or industrial product, wherein the product may be any electronic, electrical and/or electro-mechanical device, e.g., television, stereo radio, CD player, DVD player, VCR, camera, cable or satellite converter, security system, telephone, radio/alarm clock, computer, printer, facsimile machine, video display terminal, play station, toaster, toaster oven, coffee maker, kitchen or household appliance, vacuum cleaner, washer, dryer, dish washer, microwave oven, ice box, stove, cook top, oven, hair dryer, drill, saw, sander, router and the like.

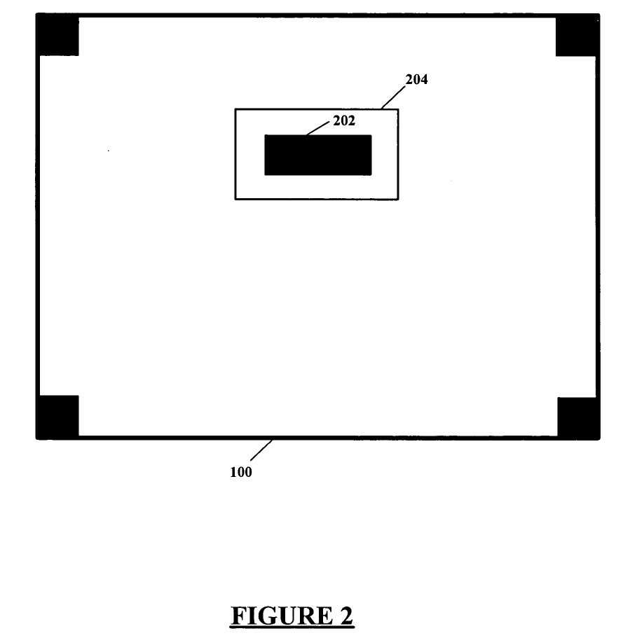

Referring now to FIG. 2, depicted is a schematic bottom view of the product 100 showing a possible location of a verification and activation module. The verification and activation module, generally represented by the numeral 202, is shown positioned in an opening or receiving interface 204 of the product 100. The verification and activation module 202 may be an electronic device that comprises nonvolatile memory. The module 202 may be a custom electronic device, or it may be a generic standard device, e.g., PCMCIA memory, a memory card, a USB memory stick, etc. A standard device module 202 preferably will store information programmed into it at the time of sale of the associated product 100.

An activation and control circuit within the product 100 preferably will use the information stored in the standard device module 202 to enable, activate and/or control the product 100. A custom electronic device module 202 may preferably do some or most of the activation and control of the associated product, or may simply enable such activation and/or control. The module 202 is preferably removable from the product 100 so that the module 202 may be used again with a replacement product which may be the same or similar to the product 100. The replacement product may be a warranty exchange, or factory exchange/repair for a defective product 100. The replacement product may be an upgrade or trade-in for the product 100. Accordingly, a product will only function for its intended purpose when the module 202 has been properly programmed, e.g., at the time of sale or of proper product or module replacement, and is properly coupled to the product in use. Without the module 202 or without a properly programmed replacement module 202, the product 100 is non-operational.

A replacement product 100 may be sent to the consumer without a module 202, but be adapted before being sent so as to receive the module 202 from the original product 100. When the module 202 is inserted into the replacement product 100, the module 202 may be reprogrammed to now only work with the replacement product 100, and to no longer work with the original product 100.

An alternative to a product return may be simply to bring just the module 202 to a service center or store where, assuming that it is within the warranty period, the module 202 may be reprogrammed to work with a replacement product (but not the original product). The consumer disposes of the original product, as it will not work with the reprogrammed original module 202 (or with an in-box module 202 that is also programmed to work only with the replacement product). This way, the store handles the return without having to handle a returned product. Also, if there is no exact replacement available in the case of a warranty return, the original product price can be compared to the replacement product price, and the consumer charged or credited for any difference due to the replacement. There may be potential problems, though, in this approach, where products are sold with separate components. For example, consumers might return a coffee maker simply to get another coffee maker carafe for free. To overcome this potential difficulty, primary product components may be packaged separately and sold together originally, but provided separately in a return situation. Or the store may simply charge the consumer the price of the primary component(s) at the time of return.

The custom module 202 may comprise, for example but not be limited to, a RFID device having wireless programming and data reading capabilities. An advantage of the wireless programming and data reading capabilities is that the RFID module 202 may be programmed independently of the product 100 and no direct connection to the module 202 is required. The memory module 202 may removably engage a mating connector located in the interface 204 of the product 100. Other locations for mounting of and connecting to the module 202 may be on or in the product 100. The module 202 may be adapted to be programmed with a point of sale interface by plugging the module 202 into the point of sale interface (not shown). The module 202 may also be programmed with a point of sale interface without physical connection thereto when using a wireless device for the module 202 (see RFID module 202 described herein).

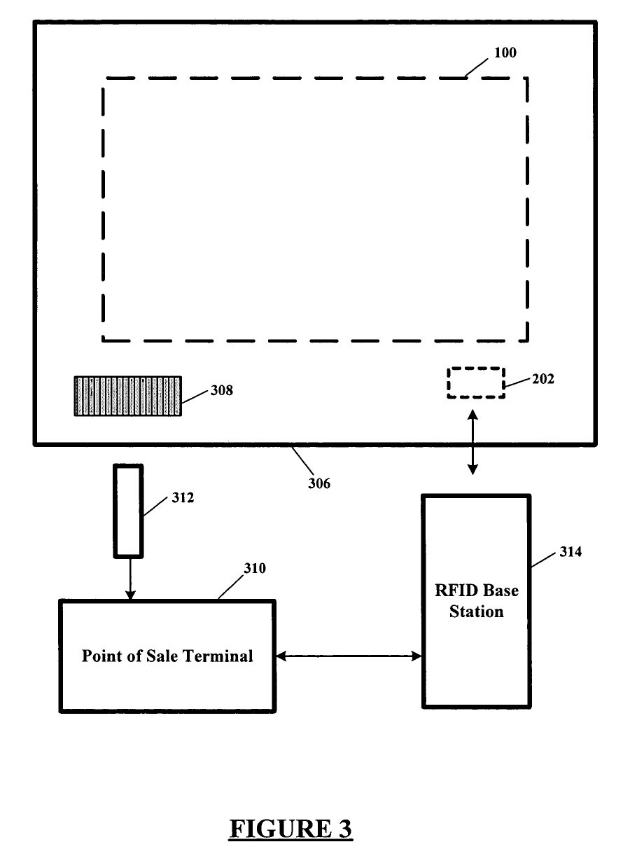

Referring now to FIG. 3, depicted is a schematic system block diagram of one embodiment of a product and its verification and activation module in a package and checkout equipment at the point of sale. The product 100 and the verification and activation module 202 is in a factory package 306. The package 306 may have a UPC label 308. When the package 306 is brought to a checkout counter, e.g., cashier, a point of sale terminal 310 uses a IR wand 312 to read the information from the UPC label 308. The verification and activation module 202 in this embodiment may be an RFID module having the capability of being written to by an RFID base station 314.

The cashier at the checkout (not shown) may enter pertinent information, e.g., store name and location, purchase price, purchase date, serial number of product, manufacturer, product model number, warranty duration, consumer name, address and other desired information. This information may be derived from the UPC label 308, preprogrammed store information, consumer information from a credit card and/or manually entered information through the point of sale terminal 310. The point of sale terminal 310 sends the pertinent information to the RFID base station 314 which transmits the information to the RFID module 202. The RFID module 202 stores the information so that when the consumer opens up the package 306, removes the product 100 and installs the module 202, the product 100 and module 202 operate together properly.

The event or transaction information also may be sent directly or indirectly to a third party, e.g., via the Internet, for processing appropriately, e.g., to the product manufacturer or a third party to track sales, to a bank or credit card company so that a purchase record may become part of the customer's monthly statement or a record accessible via the Internet, to a sweepstakes or other promotion-provider for automatic entry, and/or to a product registration organization which may track information for notifying consumers of product recalls, etc.

The RFID module 202 and RFID base station 314 may also communicate in both directions, e.g., information stored in the module 202 also may be read by the RFID base station 314. This removes having to read the information on a UPC label 308 during check out since the information that would be on the UPC label 308 can be encoded in the RFID module 202, e.g., before being shipped from the manufacturer. In addition, having a read-write RFID module 202 may greatly simplify package tracking and/or store inventory control since the contents of the package 306 can easily be read by wireless, non-line of sight means, e.g., RFID readers in the shipping trucks and stock rooms. Thus, the RFID module 202 can also be programmed with the pertinent consumer, price, warranty, etc., information without requiring a checkout person, e.g., automation of the product verification and activation. This feature is especially advantageous for a company who has sold a product 100 to a consumer via the Internet, e.g., direct Internet sales companies, for example, “amazon.com.”

Another advantage in using a RFID module 202 is that it may be a permanent part of the product 100, e.g., embedded into the product and thus need not be removable. If there is a warranty or other type of proper exchange of the original product for a new product, the information from the original product RFID module 202 may be read at the point of exchange, e.g., at a product service center the consumer visits or the defective product may be returned to a service center by United States Postal Service, UPS™, FEDEX®, etc. The information stored in the original product (e.g., defective product, product to be exchanged, etc.,) may also be transferred to the new product (e.g., replacement for the defective product, upgraded product, etc.,) by placing the original and new products in proximity to each other, e.g., the RFID encoders and decoders are part of the original and new products and can automatically initialize, connect and transfer data (e.g., consumer information, remaining warranty information, purchase price and date, etc.) and control functions (e.g., enable, disable, etc.). When the original and/or new product is energized, the information in the original product module 202 may then be transferred to the new product module 202, thereafter the original product may be disabled from further use, and the new product enabled for use by the consumer.

The verification and activation module 202 may be a direct connection programmable device, e.g., flash memory card, USB memory stick, memory module, PCMCIA card and the like. When direct connection to a point of sale terminal 310 is required, the module 202 may be removed from the package 306 at the store, programmed then placed back into the package 306 or even the product 100. In the alternative, the module 202 may be separate from the product 100 and may be programmed as described herein above, e.g., based upon the information from the UPC label 308 on the package 306, the consumer credit card, store preprogrammed information and/or information keyed into the terminal 310 by the store personnel, e.g., cashier.

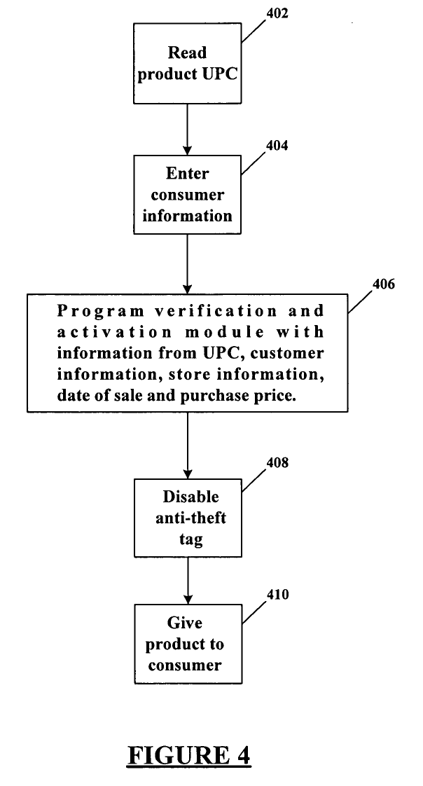

Referring now to FIG. 4, depicted is a process flow diagram of steps performed at the point of sale of the product, according to one embodiment. When a consumer takes a selected product to a cashier at a checkout counter, the cashier may read the product information from the UPC label 308 (FIG. 3) on the product package in step 402 with a UPC IR wand 312 (FIG. 3). The cashier may enter consumer information into the store's checkout counter equipment, e.g., a point of sale terminal 310. The embodiment also has similar application in a consumer or self-checkout situation without the presence of a cashier. In step 406, the store's checkout counter equipment may then program the verification and activation module 202, e.g., with an RFID base station 314 (FIG. 3) or by direct connection to the module 202. The program information of step 406 may comprise store name and location, purchase price, purchase date, serial number of product, manufacturer, product model number, warranty duration, consumer name, address and other desired information to aid in determining the date of sale, duration of warranty and actual price paid if later there is some warranty claim or other dispute regarding the product 100. In step 408, the point sale terminal 310 may optionally disable an anti-theft tag (not shown) if one is present, e.g., on the product package 306. Once all of the necessary information has been programmed into the module 202, the consumer is given the product package 306 in step 410.

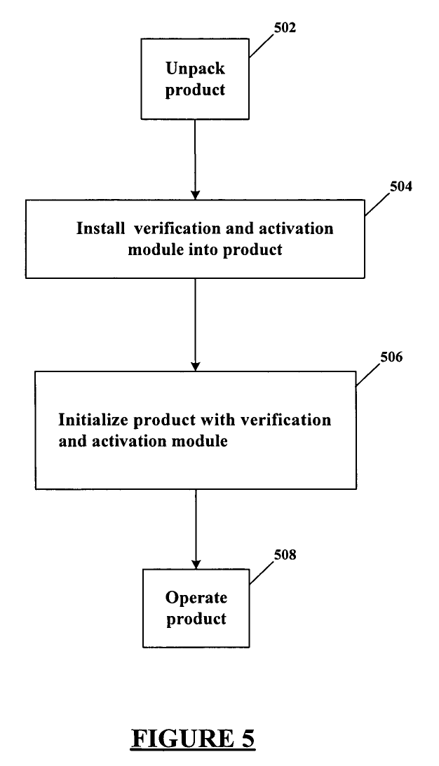

Referring now to FIG. 5, a process flow diagram of steps performed when the consumer unpacks and first uses the product, according to one embodiment. In step 502 the consumer opens the package 306 and removes the product 100 and module 202 from the package 306. The verification and activation module 202 may or may not be installed in the product 100. In step 504 the module 202 may be installed in the product 100 if not already done so earlier, e.g., at the store or manufacturer. In step 506, the product may be connected to a power source, e.g., battery or AC receptacle (not shown) and turned on for use by the consumer. Upon power being applied to the product 100, the verification and activation module may activate the product 100. Until verification and activation of the product 100 is successfully performed, the product 100 will not function. This may be a deterrent to theft, e.g., shoplifting and the like. In addition, the product 100 may be rendered inoperative if the module 202 is removed from the product 100. This may be useful in preventing theft from the consumer, and/or resale of a defective product 100 as more fully described herein below. Once the module 202 has enabled operation of the product 100 in step 508, the product 100 is henceforth ready for its intended use by the consumer.

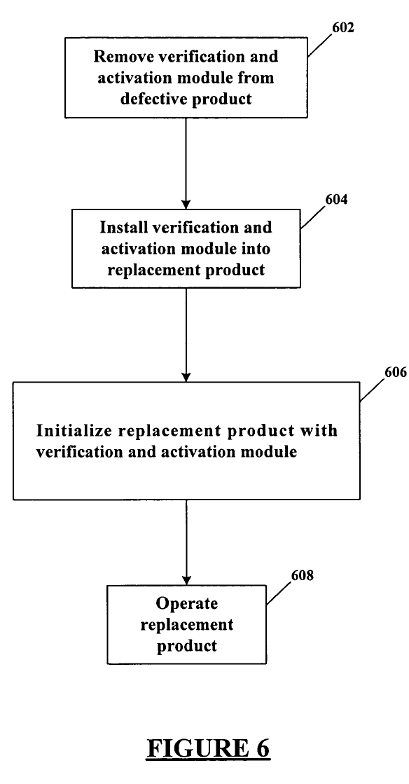

Referring now to FIG. 6, depicted is a process flow diagram of steps performed when the consumer replaces a defective product with a replacement product, according to one embodiment. Sometimes a product becomes defective, and when that happens a replacement product can be shipped directly to the consumer by the manufacturer, thus eliminating costly retail store handling and delays. Once the replacement product has been received by the consumer, in step 602 the consumer removes the verification and activation module 202 from the defective product 100. In step 604, the consumer installs the original module 202 into the new replacement product. When power is applied to the new replacement product, the module 202 will initialize the new replacement product 100 in step 606. In step 608, the new product 100 is now fully operational. The original defective product will not operate without the module 202, thus preventing a defective product from being introduced back into the stream of commerce. This prevents unsuspecting consumers from getting a defective used product.

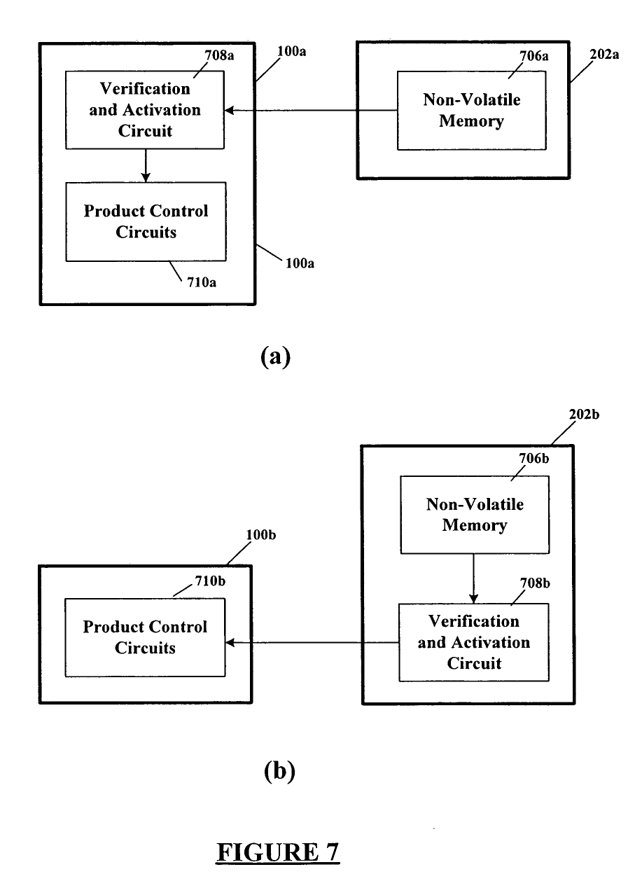

Referring now to FIGS. 7(a) and 7(b), depicted are schematic system block diagrams of two different embodiments of the product and its verification and activation module. FIG. 7(a) depicts a product 100a having an integral verification and activation circuit 708a therein which may enable the product control circuits 710a for proper operation of the product 100a. The module 202a may comprise a standard generic non-volatile memory 706a which contains information programmed at the time of sale of the product 100a. The module 202a may be, for example but not limited to, PCMCIA memory, a memory card, a USB memory stick, etc.

FIG. 7(b) depicts a product 100b having only product control circuits 710b which controls the operation of the product 10b. The module 202b may comprise verification and activation circuit 708b in combination with a non-volatile memory 706b which contains information programmed at the time of sale of the product 100a. The module 202b may be, for example but not limited to, a custom module for the respective product or may be a generic module usable over a number of products of the manufacturer.

Not shown but contemplated herein are intercommunications systems in each product that are adapted to intercommunicate with various products from a manufacturer or manufacturers, e.g., Wireless Fidelity (WiFi), Bluetooth, etc. Two products may transfer the stored information from one to another, disable the original product and enable the replacement product without external communications or programming equipment. The only limiting factor in the application, flexibility and use of the invention is the sophistication of the verification and activation module (and any accompanying communications circuits) versus the cost of its implementation into the product. The exact preferred implementation of the invention may depend upon the product cost.

The verification and activation module may also be used for storing service and warranty information of the product, e.g., required maintenance performed, repair history, etc. Thus, if a product is replaced or repaired under warranty the verification and activation module can maintain a history of warranty and/or repair activities for the product throughout any repair and/or replacement thereof. This product history may be useful for product studies, e.g., reliability, warranty costs, product recalls, updates, consumer use patterns, etc. The product history may be updated and/or read via a connection to a communications port of the product, e.g., wireless, Ethernet, etc., e.g., over a telephone modem or the Internet.

The verification and activation module may also be used for security and/or theft deterrence. A product may be activated at its point of use, e.g., home or office kitchen, family room, etc., and if moved from its intended point of use, the product may be disabled by the verification and activation module. The product may comprise a global position satellite (GPS) system that may determine the location of the product and a code may be entered to activate the product at that location. If the product is moved outside of a certain distance from that GPS determined location, the product may be deactivated unless a reactivation code is entered into the product at its new location. A cellular or satellite communication system may be included into the product so that the product can “call for help” if the reactivation code is not forthcoming. In effect the product knows that it has been stolen because of a change in location without confirmation that the location change was authorized, and thereby may deactivate and further may alert where it is now located.

Security activation of the product through the verification and activation module may be performed over a wireless digital network, e.g., Wireless Fidelity (WiFi) technology, Bluetooth, etc., that operates within defined geographical boundaries. If the product is removed outside of the defined geographical boundaries, it ceases to function. Thus, if a product is stolen and removed from the rightful owner's home or office, the product may render itself useless. A security code, e.g., a rolling code may be used within the wireless technology so that the security code may not be easily replicated. Carrier current communications is also contemplated herein and may be used to communicate with the product once it is plugged into a power outlet. Communications may be with a computer network server and access may also be available to the Internet. This security activation may be used in combination with home and office automation of products therein. A “heartbeat” may be used to determine the presence of a product over a network and if the presence of the product is not sensed, an alarm may be generated to a security monitoring system.

The invention, therefore, is well adapted to carry out the objects and to attain the ends and advantages mentioned, as well as others inherent therein. While the invention has been depicted, described, and is defined by reference to embodiments of the invention, such references do not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

1. An apparatus, comprising:
a product having control circuits; and
a verification and activation module coupled to the control circuits of the product, wherein the verification and activation module activates the control circuits of the product.

2. The apparatus of claim 1, wherein the verification and activation module is removably coupled to the product.

3. The apparatus of claim 2, wherein the control circuits of the product are deactivated when the verification and activation module is not coupled to the product.

4. The apparatus of claim 1, wherein the verification and activation module is programmed with information.

5. The apparatus of claim 4, wherein the programmed information comprises purchase date and price of the product.

6. The apparatus of claim 4, wherein the programmed information comprises warranty information for the product.

7. The apparatus of claim 4, wherein the programmed information comprises data about a consumer who purchased the product.

8. The apparatus of claim 4, wherein the programmed information comprises data about a manufacturer of the product.

9. The apparatus of claim 4, wherein the programmed information comprises data about the product.

10. The apparatus of claim 4, wherein the verification and activation module comprises a non-volatile programmable memory.

11. The apparatus of claim 10, wherein the non-volatile memory is selected from the group consisting of electrically erasable and programmable read only memory (EEPROM), Flash memory and battery backed-up random access memory (RAM).

12. The apparatus of claim 10, wherein the product comprises verification and activation circuits.

13. The apparatus of claim 4, wherein the verification and activation module comprises a non-volatile programmable memory, and verification and activation circuits.

14. The apparatus of claim 1, further comprising a security feature that deactivates the product when outside of a geographical location.

15. The apparatus of claim 1, further comprising a security feature that deactivates the product when a security signal is not present.

16. The apparatus of claim 10, wherein warranty history of the product is stored in the non-volatile memory.

17. The apparatus of claim 10, wherein repair history of the product is stored in the non-volatile memory.

18. The apparatus of claim 10, wherein maintenance history of the product is stored in the non-volatile memory.

19. The apparatus of claim 1, further comprising a communications interface coupled to the verification and activation module.

20. The apparatus of claim 19, wherein the communications interface is selected from the group consisting of WIFI and Bluetooth.

21. A system for verifying and activating a product upon purchase by a consumer, said system comprising:
a product;
a verification and activation module;
a point of sale terminal; and
a module programmer for programming the verification and activation module, the module programmer is coupled to the point of sale terminal, wherein information from the point of sale terminal is programmed into the verification and activation module so that the product is activated when coupled to the verification and activation module.

22. The system of claim 21, further comprising a package, wherein the product is in the package.

23. The system of claim 22, wherein the verification and activation module is in the package.

24. The system of claim 22, further comprising a universal product code (UPC) label on the package.

25. The system of claim 24, further comprising a UPC reader coupled to the point of sale terminal, wherein part of the information programmed into the verification and activation module is from the UPC label.

26. The system of claim 21, further comprising a credit card reader that is adapted to read a credit card, the credit card reader is coupled to the point of sale terminal, wherein some of the information programmed into the verification and activation module is from the credit card.

27. The system of claim 21, wherein the programmed information comprises purchase date and price of the product.

28. The system of claim 21, wherein the programmed information comprises warranty information for the product.

29. The system of claim 21, wherein the programmed information comprises data about a consumer who purchased the product.

30. The system of claim 21, wherein the programmed information comprises data about a manufacturer of the product.

31. The system of claim 21, wherein the verification and activation module includes an RFID device and the module programmer comprises an RFID programmer.

32. The system of claim 31, wherein the RFID programmer further comprises an RFID reader for reading information stored in the RFID device.

33. A system for verifying and activating a product upon purchase by a consumer, said system comprising:
a package;
a product in the package;
a verification and activation module in the package;
a universal product code (UPC) label on the package;
a UPC reader;
a point of sale terminal coupled to the UPC reader; and
a module programmer for programming the verification and activation module, the module programmer is coupled to the point of sale terminal, wherein information from the UPC reader and the point of sale terminal are programmed into the verification and activation module.

34. The system of claim 33, wherein the information from the UPC reader and the point of sale terminal are programmed into the verification and activation module by wireless transmission.

35. The system of claim 34, wherein the wireless transmission is by radio frequency signals.

36. The system of claim 34, wherein the wireless transmission is by infrared signals.

37. The system of claim 34, wherein the wireless transmission is by electromagnetic signals.

38. A system for replacing an original product with a replacement product, said system comprising:
an original product;
a verification and activation module coupled to the original product; and
a replacement product, wherein when the verification and activation module is removed from the original product and coupled to the replacement product, the replacement product is enabled for operation and the original product is disabled from operation.

39. The system of claim 38, wherein once the replacement product has been enabled for operation by the verification and activation module, the original product cannot be enabled again by the verification and activation module.

40. A system for replacing an original product with a replacement product, said system comprising:
an original product having a first verification and activation module; and
a replacement product having a second verification and activation module, wherein when the first verification and activation module is in communication with the second verification and activation module, the replacement product is enabled for operation and the original product is disabled from operation.

41. The system of 40, wherein the communication is wireless.

42. The system of 40, wherein the communication is by wire.

43. A method for activating a product, said method comprising the steps of:
reading product information from a universal product code (UPC) label;
entering consumer information;
programming the product information and the consumer information into an activation module; and
activating the product with the activation module.

44. The method of claim 43, further comprising the step of programming store information into the activation module.

45. The method of claim 43, further comprising the step of programming warranty information into the activation module.

46. The method of claim 43, further comprising the step of programming purchase date and price of the product into the activation module.

47. The method of claim 43, further comprising the step of programming data about a manufacturer of the product into the activation module.

48. A method for replacing an original product with a replacement product, said method comprising the steps of:
providing an original product having a verification and activation module;
providing a replacement product; and
removing the verification and activation module from the original product; and
installing the verification and activation module in the replacement product, wherein the replacement product is enabled for operation and the original product is disabled from operation.

49. A method for replacing an original product with a replacement product, said method comprising the steps of:
providing an original product having a first verification and activation module;
providing a replacement product having a second verification and activation module; and
communicating between the first and second verification and activation modules such that the replacement product is enabled for operation and the original product is disabled from operation.

50. A method for product security, said method comprising the steps of:
providing a product having a verification and activation module; and
communicating with the verification and activation module such that the product is enabled for operation when a correct security code is communicated to the verification and activation module.

51. A method for retaining product service information, said method comprising the steps of:
providing a product having a verification and activation module, wherein the verification and activation module has a non-volatile memory; and
writing into the non-volatile memory service information.

52. The method of claim 51, wherein the product service information is selected from the group consisting of warranty repair and replacement of the product.
